(19) United States
(12) Patent Application Publication
(10) Pub. No.: US 2024/0237682 A1
(43) Pub. Date: Jul. 18, 2024

(54) HYDROLYSIS PROCESS FOR COFFEE SUBSTITUTE BEVERAGE

(71) Applicant: Koji Coffee Co. LLC, Provo, UT (US)

(72) Inventor: Jonathan ARNOLD, Provo, UT (US)

(21) Appl. No.: 18/414,189

(22) Filed: Jan. 16, 2024

Related U.S. Application Data
(60) Provisional application No. 63/439,347, filed on Jan. 17, 2023.

(51) Int. Cl. A23L 7/104; A23F 5/44; A23L 2/38

(52) U.S. Cl. CPC A23L 7/107; A23F 5/44; A23L 2/382

(57) ABSTRACT

Disclosed is a method of manufacturing a substrate that can be used to make a coffee substitute beverage. Initially, a starch-containing and protein-containing substrate is exposed to a plurality of enzymes including at least glycosidase and protease enzymes. The substrate undergoes an aging process while exposed to the plurality of enzymes. The substrate is subsequently subjected to temperatures to initiate a Maillard reaction. The coffee substitute beverage made from the prepared substrate provides benefits over conventional coffee alternatives.

### CROSS-REFERENCE TO RELATED APPLICATIONS

This application claims priority to, and the benefit of, U.S. Provisional Application Ser. No. 63/439,347, filed Jan. 17, 2023, and titled “Hydrolysis Process for Coffee Substitute Beverage,” the entirety of which is incorporated herein by reference.

### BACKGROUND

Koji mold is used in the koji process to create food products. The koji mold is a filamentous fungus such as Aspergillus oryzae or Aspergillus sojae. Some examples of koji products include when the koji mold is added to steamed rice to produce koji rice and further used to produce sake from koji rice, soy beans to produce soy sauce, or steamed soya beans and roasted, cracked wheat to produce shoyu soya sauce.

The koji process initially begins with obtaining the koji mold culture and adding it to the desired starting product, for example rice. The rice and koji mold are then placed in a warm and humid environment for an amount of time. During this time, the koji mold feeds on the rice and breaks down carbohydrates and proteins in the rice using enzymes found in the koji mold. As the koji mold breaks down carbohydrates and proteins, amino acids and simple sugars are released which add to the flavor of the end product.

### BRIEF SUMMARY

The present disclosure relates to methods for manufacturing a substrate that can be used to make a coffee substitute beverage. The coffee substitute beverage made using the disclosed methods provides benefits over conventional coffee alternatives. For example, in blind taste testing, the coffee substitute beverage of the present disclosure received higher overall enjoyment scores than all other tested coffee alternatives. Moreover, the prepared substrate manufactured using the disclosed methods beneficially allows for espresso-style brewing. Other coffee alternatives are typically not capable of use in espresso-style brewing and are instead intended to be brewed using immersion or percolation techniques.

The method begins with a starch-containing and protein-containing substrate. The substrate is exposed to a plurality of enzymes comprising at least glycosidase (e.g., glucosidase) and protease enzymes. The substrate is then aged (while remaining exposed to the enzymes) for a time period sufficient to convert at least a portion of the starch and protein into simple sugars and amino acids. The substrate is then subjected to a temperature sufficient to initiate a Maillard reaction until a desired degree of the reaction has occurred. Following the Maillard reaction, the substrate may be physically processed such as grinding to increase the surface area to volume ratio of the substrate.

In some embodiments, exposing the substrate to a plurality of enzymes is carried out by inoculating the substrate with an inoculant and allowing a fermentation process to occur in which inoculant organisms generate the enzymes. The inoculant may include Aspergillus fungi such as Aspergillus oryzae, Aspergillus sojae, Aspergillus awamori, and/or Aspergillus luchuensis.

In some embodiments, the method includes a first stage of fermenting in an aerobic environment followed by a second stage carried out in an anaerobic environment. In some embodiments, the first stage is carried out at a first temperature and the second stage is carried out at a second, different temperature. For example, the first temperature may be 70° F. to 95° F. or 75° F. to 90° F. and the second temperature may be 33° F. to 50° F. or 35° F. to 45° F. In other embodiments, the second temperature may be about room temperature, a temperature substantially similar to the first temperature, or a temperature higher than the first temperature.

In some embodiments, the first stage is carried out for a first time period and the second stage is carried out for a second, typically longer time period. For example, the first time period can be 24 hours to 72 hours or 36 hours to 60 hours, and the second time period can be 96 hours or greater (e.g., 5 days or more, 7 days or more, 10 days or more, 12 days or more, or 14 days or more), which may extend up to about 14 days, 21 days, 28 days, 6 months, or a year for example.

In some embodiments, exposing the substrate to a plurality of enzymes includes contacting the plurality of enzymes directly to the substrate (i.e., rather than indirectly through inoculation with Aspergillus fungus). In such embodiments, the substrate can optionally be additionally inoculated with an Aspergillus fungus.

The enzymes to which the substrate is exposed (through inoculation and/or through direct addition) may include α-amylase, glucoamylase, β-galactosidase, β-glucosidase, β-glucanase (such as Endo-1,4-glucanase), protease (such as an acid, neutral, and/or alkaline protease), lipase, tannase, glutaminase, and/or keratinase.

In some embodiments, the substrate includes one or more cereal grains, pseudocereals, nuts, seeds, legumes, mushrooms, tubers, roots, or a combination thereof. In some embodiments, the cereal grain or pseudocereal includes one or more of wheat, rye, oats, barley, rice, millet, corn/maize, sorghum, triticale, buckwheat, quinoa, chia, amaranth, breadnut, cañahua, cockscomb, pitseed goosefoot, or acacia. In some embodiments, products made from one or more of the above substrates (e.g., crackers, pasta, bread) are used.

In some embodiments, the substrate is subjected to liquid-solid extraction, using water (e.g., brewing), to obtain a beverage. In some embodiments, the liquid-solid extraction includes percolation, immersion, pressurized percolation, or pressurized immersion.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

### BRIEF DESCRIPTION OF THE DRAWINGS

Various objects, features, characteristics, and advantages of the invention will become apparent and more readily appreciated from the following description of the embodiments, taken in conjunction with the accompanying drawings and the appended claims, all of which form a part of this specification. In the Drawings, like reference numerals may be utilized to designate corresponding or similar parts in the various Figures, and the various elements depicted are not necessarily drawn to scale, wherein:

FIG. 1 illustrates an example method of manufacturing a prepared substrate for use in a beverage.

### DETAILED DESCRIPTION

The present disclosure relates to methods for manufacturing a substrate that can be used to make a coffee substitute beverage. The coffee substitute beverage made using the disclosed methods provides benefits over conventional coffee alternatives. For example, in blind taste testing, the coffee substitute beverage of the present disclosure received higher overall enjoyment scores than all other tested coffee alternatives.

Koji mold is generally used in the koji process to produce koji rice, soy sauce, sake, miso, and other consumer products. The koji mold contains a plurality of enzymes that can break down carbohydrates and proteins. When the koji mold is added to an initial substrate, the enzymes in the koji mold break down the substrate, releasing carbohydrates and proteins to generate simple sugars and amino acids that add flavor to the final product. While the conventional koji process has generally been used for the above-mentioned products (koji rice, soy sauce, sake, miso), the presently disclosed embodiments beneficially use a koji process to produce an improved coffee substitute beverage.

### Process Overview

Initially, a starch-containing and protein-containing substrate is provided. In some embodiments, the starch-containing and protein-containing substrate is cooked. As an example, the starch-containing and protein-containing substrate may be barley. The cooking of the substrate minimizes ‘mushiness’ of the substrate. If the substrate is mushy, the substrate may not be able to be roasted effectively in subsequent process steps. This initial cooking step is optional and may be omitted in other embodiments.

After the initial cooking of the substrate (if such a step is utilized), the substrate is exposed to a plurality of enzymes. In some embodiments, this step comprises inoculating the substrate with spores from a mold capable of providing enzymes for the breakdown of starch and protein in the substrate. The mold may be a koji mold. In some embodiments the mold comprises Aspergillus oryzae, Aspergillus sojae, Aspergillus awamori, Aspergillus luchuensis, other mold, or combination thereof. Other embodiments additionally or alternatively comprise direct addition of one or more enzymes (e.g., instead of indirectly providing the enzymes through an enzyme-producing mold).

In embodiments utilizing inoculation, the inoculated substrate is then incubated in a warm, humid environment for a period of time. In some embodiments the inoculated substrate is incubated at 70° F. to 95° F. (e.g., 86° F.) and greater than 80% humidity (e.g., greater than 85% humidity, such as 90% humidity) for 24 to 72 hours (e.g., 48 hours).

The inoculated and incubated substrate can then be aged in an anerobic environment for a period of time. In some embodiments, the aging process is carried out at 33° F. to 50° F. (e.g., 40° F.) for 96 hours or more (e.g., about 14 days), though higher temperatures and shorter time periods may be utilized.

The processed substrate can then be roasted at a high temperature until a desired level of roasting is achieved. In some embodiments, the substrate may be roasted at 400° F. until the substrate is dark brown in color. The roasted substrate may then be ground and brewed in a similar fashion to coffee beans.

### Example Organic Components

In some embodiments, the substrate includes barley and/or oats. The substrate may additionally or alternatively include cereal or pseudocereal grains, nuts, seeds, legumes, tubers, roots, mushrooms, and/or other starch-containing and protein-containing substrates. Cereal and pseudocereal grains may include wheat, rye, oats, barley, rice, millet, corn/maize, sorghum, triticale, buckwheat, quinoa, chia, amaranth, breadnut, cañahua, cockscomb, pitseed goosefoot, or acacia. In some embodiments, more than one substrate may be used in combination. In some embodiments, products made from one or more of the above listed substrates (e.g., bread, crackers, or pasta) may be used.

The enzymes are used to break down the starch and protein in the substrate. In some embodiments, enzymes may come from enzyme-producing fungus. Examples of enzyme producing fungus include Aspergillus oryzae, Aspergillus sojae, Aspergillus awamori, Aspergillus luchuensis, other Aspergillus fungus, or combination thereof. Additionally, or alternatively, the enzymes may come from direct exposure. That is, enzymes may be directly added to the substrate. In some embodiments, the enzymes are produced using yeasts, bacteria, or other enzyme-producing organisms.

The enzymes primarily break down starch and protein into amino acids and simple sugars, possibly with some fatty acids. Examples of the enzymes may include α-amylase, glucoamylase, β-galactosidase, β-glucosidase, β-glucanase, protease, lipase, tannase, glutaminase, keratinase, other starch and/or protein enzymes, and combinations thereof. A further example of β-glucanase includes Endo-1,4-β-glucanase. Protease may be an acid, neutral, and/or alkaline protease. In some embodiments, a cocktail of specifically selected enzymes may be used. In other embodiments, the choice of enzymes is based on the fungus used. A combination of the above-listed enzymes can be used.

### Detailed Process Steps

Prior to the step of exposing the substrate to a plurality of enzymes, the substrate can be hydrated. In the example of cereal grains, pseudocereal grains, and legumes, the substrate is hydrated with water or other appropriate liquid. In the example of mushrooms, tubers, and roots, the substrate may have high enough water content and not require more water. In the example of dehydrated mushrooms, tubers, and roots, the substrate can be hydrated with water. In some embodiments, the substrate is optionally cooked to gelatinize the starch content. Other appropriate means of preparing the substrate may also be used. Overall, the substrate can be prepared so as to have an appropriate water content for interacting with the enzymes.

In preferred embodiments, the substrate has not been germinated. That is, the substrate is preferably non-sprouted and non-malted.

The enzymes to which the substrate is exposed may include α-amylase, glucoamylase, β-galactosidase, β-glucosidase, β-glucanase (such as Endo-1,4-β-glucanase), protease (such as an acid, neutral, and/or alkaline protease), lipase, tannase, glutaminase, keratinase, or a mixture thereof.

Enzyme-producing organisms may include filamentous fungi (e.g., Aspergillus fungus as disclosed elsewhere herein), yeasts, and/or bacteria. In some embodiments, specific enzymes may be chosen. In other embodiments, enzymes may be generated by enzyme-producing organisms. In some embodiments, the enzymes comprise at least glycosidase (e.g., glucosidase) and protease enzymes, including any combination of the examples of such enzymes disclosed elsewhere herein.

The substrate is exposed to the enzymes to cause hydrolysis of components of the substrate. In some embodiments, the hydrolysis of the substrate with the enzymes is performed in a dry environment (e.g., in ambient atmosphere). In other embodiments, the hydrolysis of the substrate with the enzymes is performed in an aqueous environment (e.g., with the substrate fully or partially submerged in water).

The substrate is exposed to the enzymes at a selected temperature over a selected time period to achieve a sufficient degree of hydrolysis of the substrate. This process may be referred to herein as the hydrolysis process or hydrolysis step. In some embodiments, the enzyme exposure is performed at relatively higher temperatures and requires less time. In other embodiments, the hydrolysis process is performed at relatively lower temperatures and requires more time. The temperature should be within a range where the selected enzymes are stable and denaturing of the enzymes is avoided. In some embodiments, the hydrolysis process may be performed at about 70° F. for about 24 hours. In other embodiments, the hydrolysis process may be performed at about 40° F. for about 18 days. In even other embodiments, the hydrolysis process may be performed according to the following equation (e.g., within temperature ranges according to any of the other examples disclosed herein):

$$Time ( days ) = \frac{23466}{{Temperature ( ° F . )}^{2}} - 0.66 .$$

The above equation assumes a standard level of hydrolysis enzymes equivalent to the amount present at the conclusion of a standard batch of koji rice or koji soybeans. In embodiments where the enzyme level is different, the result may be linearly scaled accordingly.

In some embodiments, a sufficient degree of hydrolysis is determined based upon the desired characteristics of the desired beverage. For example, a particular aroma and/or flavor may be desired in a final beverage. In this instance, a higher degree of hydrolysis is desired. For a less intense flavor, less hydrolysis may be desired.

In some embodiments, the hydrolysis process is broken up into a fermentation process and an aging process. In some embodiments, the fermentation process is carried out at a first temperature such as below 70° F., or more preferably about 70° F., about 75° F., about 80° F., about 90° F., or about 95° F., though in some cases it may be carried out above 95° F. A temperature within a range using any of the foregoing values as endpoints may be used.

In some embodiments, the aging process is carried out at a second temperature such as below 33° F., or more preferably about 33° F., about 35° F., about 40° F., about 45° F., or about 50° F., though in some cases it may be carried out above 50° F. A temperature within a range using any of the foregoing values as endpoints may be used.

In some embodiments, the second temperature is lower than the first temperature (i.e., the aging process is carried out at a lower temperature than the fermentation process). In other embodiments, the aging process is carried out at a temperature of about 70° F., about 90° F., about 110° F., about 130° F., about 160° F., or above 160° F. (or a temperature within a range using any of the foregoing values as endpoints).

In some embodiments, the fermentation process occurs in an aerobic environment and the aging process occurs in an anaerobic environment.

In some embodiments, the fermentation process occurs at a first time period such as less than 24 hours, about 24 hours, about 30 hours, about 36 hours, about 40 hours, about 50 hours, about 60 hours, about 72 hours, or more than 72 hours (or a time period within a range using any of the foregoing values as endpoints).

In some embodiments, the aging process occurs over a second time period such as less than 4 hours (but preferably at least 30 minutes), about 4 hours, about 96 hours, about 5 days, about 7 days, about 10 days, about 12 days, about 14 days, or more than 14 days (or a time period within a range using any of the foregoing values as endpoints). In some embodiments, the second time period is longer than the first time period (i.e., the aging process is longer than the fermentation process). For example, the second time period may be longer than the first time period by a factor of at least 1.5, at least 2, at least 2.5, at least 3, at least 3.5, at least 4, at least 4.5, at least 5, at least 5.5, at least 6, at least 6.5, at least 7, at least 7.5, at least 8, at least 8.5, at least 9, at least 9.5, or at least 10.

In some embodiments, yeast is added to the substrate during the aging process. The yeast may be bakers' yeast, Kvass yeast, Saison yeast, or other culinarily appropriate yeast. In some embodiments, a combination of yeasts are added to the substrate. In some embodiments, the yeast functions to limit or prevent harmful bacteria from growing on the substrate. Additionally, or alternatively, the yeast adds to the flavor profile of the final processed product.

After the hydrolysis process, a Maillard reaction is allowed to occur. The Maillard reaction is a chemical reaction between amino acids and reducing sugars resulting in distinctive flavors. The Maillard reaction may be catalyzed at varying temperatures. In some embodiments, the substrate is subjected to a temperature sufficient to initiate the Maillard reaction. In some embodiments, the temperature sufficient to initiate the Maillard reaction is room temperature. In other embodiments, the temperature sufficient to initiate the Maillard reaction is less than 150° F., about 150° F., about 200° F., about 250° F., about 300° F., about 350° F., about 400° F., about 450° F., about 500° F., or above 500° F. (or a temperature within a range using any of the foregoing values as endpoints). In some embodiments, initiate the Maillard reaction includes subjecting the substrate to a temperature and time according to the following equation (optionally with minimum and/or maximum temperatures according to any of the other examples disclosed herein):

$$Time ( hours ) = {e}^{\frac{2078}{Temperature {(}^{∘} F . )} - 2.32} .$$

In some embodiments, the temperature the substrate is subjected to varies once the Maillard reaction is initiated. In embodiments where the temperature is varied, the temperature may be varied based on a desired flavor profile.

In some embodiments, the substrate is physically processed following the Maillard reaction. The physical processing may include grinding the substrate to increase the surface area to volume ratio of the substrate. In some embodiments, a set of burs is used to grind the product. In other embodiments, other grinding methods may be used to achieve a desired size. In some embodiments, a general coffee grinder may be used including mechanical grinders, electric grinders, grinders in brewing devices, or other appropriate grinding methods. In some embodiments, the processed substrate is left in a whole state and is not ground.

In some embodiments, the physically processed substrate is subjected to a liquid-solid extraction to produce a beverage. The liquid-solid extraction may use water in some embodiments. In some embodiments, the liquid-solid extraction uses percolation, immersion, pressurized percolation, pressurized immersion, or other appropriate liquid-solid extraction techniques. In some embodiments, liquid-solid extraction may be performed using a French press, a coffee maker, an espresso maker, a cold brew device, a drip coffee maker, a pour over coffee maker, or other appropriate liquid-solid extraction devices.

Particular flavors, aromas, and other tasting profiles may be extracted from the processed substrate based on brewing methods. Any appropriate brewing methods for coffee may be used for precise profile extraction.

In some embodiments, insoluble materials are removed from the beverage. In other embodiments, some insoluble materials are left in the beverage. In even other embodiments, all insoluble materials are left in the beverage.

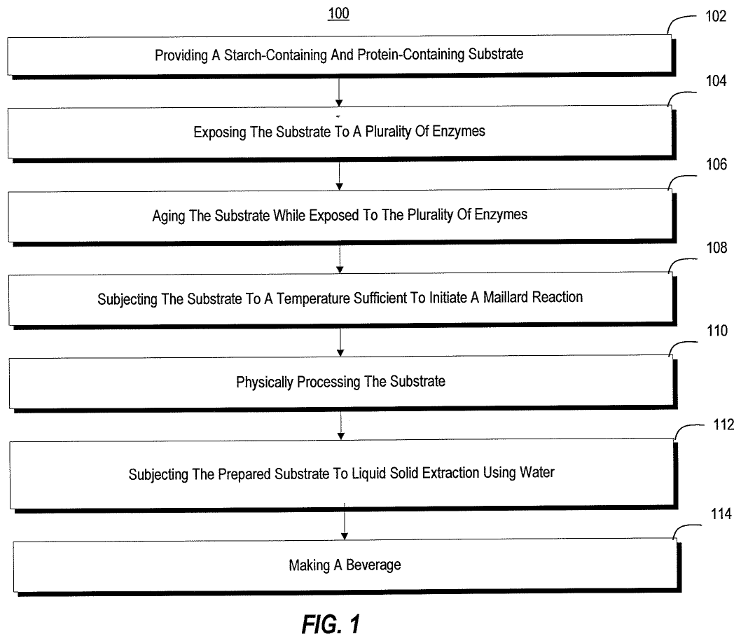

FIG. 1 illustrates a method 100 of preparing a substrate for use in making a beverage. In act 102, a starch-containing and protein containing substrate is provided. In an example, the substrate comprises barley and/or oats. The substrate is exposed to a plurality of enzymes (act 104) such as glycosidase (e.g., glucosidase) and protease enzymes. In some embodiments, exposing the substrate to the enzymes comprises inoculating the substrate with an Aspergillus fungus and allowing a fermentation process to occur. While the substrate is exposed to the plurality of enzymes, the substrate is aged (act 106). The substrate is then subjected to a temperature sufficient to initiate a Maillard reaction (act 108). In some embodiments, the temperature sufficient to initiate the Maillard reaction is room temperature. In other embodiments, the temperature sufficient to initiate the Maillard reaction is above room temperature. The prepared substrate is physically processed (act 110). For example, the prepared substrate may be ground to increase the substrate surface area to volume area. In some embodiments, the prepared substrate is subjected to a liquid-solid extraction using water (act 112). In one example, using an espresso machine using hot water. Lastly, a beverage is made from the liquid-solid extraction (act 114). In some embodiments, this beverage is a coffee-like beverage.

### Example Benefits

Embodiments of the invention can produce a coffee-like beverage with particular benefits. The beverage made from the processed substrate may include a desirable flavor profile. This flavor profile may be superior to other coffee-like beverages. The produced beverage may be processed to include desired starch content, sugar content, moisture content, carbohydrate content, or other desired characteristics. The coffee-like beverage may mimic the flavor profile of an actual coffee beverage more than other coffee substitute beverages. The processing of the substrate may be controlled to give desired characteristics that may not be possible in other coffee-substitute beverages.

In some embodiments, the processed substrate may be used in espresso-style brewing. Other coffee alternatives are typically not capable of use in espresso-style brewing. For example, other coffee alternatives are typically intended to be cold brewed or brewed in a French press. Embodiments of the invention are beneficial as the processed substrate may be exposed to espresso-style brewing to create a coffee substitute beverage. The coffee-like beverage produced from the processed substrate and brewed using espresso methods mimics espresso style coffee more effectively than other coffee substitutes.

The prepared substrate manufactured according to the present disclosure may be formed as a processed substrate, ground processed substrate, or beverage, allowing consumers flexibility in purchasing various forms of the coffee-like beverage. In the case of the processed substrate or ground processed substrate, consumers may brew at home and/or otherwise customize how their beverage is made depending on personal preferences.

### EXPERIMENTAL EXAMPLES

### Example 1

An experimental study was performed comparing differences between (1) an aged koji beverage prepared according to a preferred embodiment of the present disclosure, and (2) an un-aged/fresh koji beverage.

In the experiment, a “fresh koji” and “aged koji” were compared. The “fresh koji” included a sample of fresh Aspergillus oryzae which had been grown on barley for 48 hours at a temperature of about 86° F. and 90% humidity. The “fresh koji” was then roasted using a hot air roaster.

The “aged koji” included a sample of Aspergillus oryzae grown on barley for 48 hours at a temperature of about 86° F. and 90% humidity. The “aged koji” was then inoculated with brewer's yeast and aged for 96 hours at 40° F. in an anaerobic environment prior to being roasted using a hot air roaster. Both the “fresh koji” and the “aged koji” were coarsely ground.

In the experiment, 15 g of “fresh koji” and 15 g of “aged koji” were weighed and placed in a V60 coffee filter. Two samples were created (one from the “fresh koji” and one from the “aged koji”) by extraction with 250 ml of water at 100° C. Both samples were cooled to 20° C. and 3 drops were placed on a refractometer using a dropper. Brix readings were then taken of both samples.

The Brix standard measurement generally measures the dissolved solids in a liquid and is commonly used to measure dissolved sugar. The fresh koji beverage had a 2.2 degrees Brix measurement while the aged koji beverage had a 3.4 degrees Brix measurement.

The Brix measurement also shows the aged koji beverage extracted more sugar than the fresh koji beverage. The ratio of initial mass to extracted sugar from the beverage was measured for both beverages. The fresh koji beverage had an initial mass to extracted sugar ratio of 1:0.367 and the aged koji had an initial mass to extracted sugar ratio of 1:0.567. This result shows the aged koji beverage extracted more sugar than the fresh koji beverage.

### Example 2

A blind taste test experiment was performed to compare disclosed embodiments to other coffee-like beverages. Disclosed embodiments, using the koji coffee-like beverage, were compared to Pero and Teeccino. Pero is a cereal coffee made with malted barley. Teeccino is a roasted herbal tea that has a coffee-like taste.

The koji beverage was prepared by carrying out the following steps:
Boil 750 g oats for 18 min
Inoculate with 1 g of A. Oryzae spores
Incubate for 48 hours at 86° F.
Break into small pieces
Age for 12 hours at 140° F. in an anaerobic environment
Dehydrate for 10 hours
Hot air roasting for 3 min 15 sec
Grind and brew

In the experiment, nine participants participated in a blind taste test of (1) the koji coffee-like beverage, (2) Pero, and (3) Teeccino. Each beverage was rated on a scaled of 1 to 10 based on the following six criteria:
1. How much does the flavor linger?
2. How much does the flavor build as you take repeated sips?
5. How much body does the beverage have?
4. How much depth of flavor does the cup have?
5. How intense is the flavor?
6. How much did you enjoy the overall experience?

Results of the experiment are shown below in Table 1. Each column in Table 1 relates to one of the six questions above. The values in Table 1 show the scores for the koji beverage relative to the Pero and Teecino beverages. For example, regarding linger, the koji beverage scored 12% lower than Pero and 12% higher than Teeccino.

TABLE 1

| | Linger | Build | Intensity | Depth | Body | Enjoyment |
|---|---|---|---|---|---|---|
| Pero | −12% | 0% | +13% | −6% | +4% | +15% |
| Teeccino | +12% | +19% | +30% | +24% | +19% | +11% |

In more detail, results of the experiment showed 5 of the 9 participants, or 56%, gave the koji coffee-like beverage the highest score on enjoyment, while 2 of the remaining participants, or 22%, gave Pero the highest score on enjoyment and the remaining 2, another 22%, gave Teeccino the highest score on enjoyment. In other words, the koji coffee-like beverage scored 15% higher on average than Pero for enjoyment and 11% higher than Teeccino.

Overall the koji-based coffee-like beverage scored higher in overall enjoyment, body, intensity, and linger than both Pero and Teeccino. The koji coffee-like beverage also scored higher than Teeccino in every aspect.

As shown in the blind taste test experiment, the koji coffee-like beverage described herein produces a more enjoyable coffee-like beverage compared to other conventional, commercially sold coffee-like substitutes.

### Example 3

Additional tests on the processed koji coffee-like beverage may be performed to show benefits compared to other coffee-like beverages.

One example is the cupping test. In the cupping test, the processed substrate described above is used to create a beverage. Other coffee substitute beverages are also made (e.g., brewed chicory-based beverages and malted barley beverages). An evaluation of the disclosed invention beverage and other beverages is made. The evaluation may include aroma and flavor (e.g., good, medium, bad) and acidity, body and balance (e.g., high, medium, low). An aftertaste is also evaluated after spitting the coffee-like beverage. The defects of processing and roasting may also be evaluated. Processing defects may include pulpy, fruity, fermented, stinker, onion, hidy, chemical, phenol, earthy, muddy, mouldy, and musty. Roasting defects may include scorched or baked.

The cupping test of the disclosed beverage results in a good aroma and flavor rating compared to other coffee-like beverages which result in a medium aroma and flavor rating. The disclosed beverage results in a low acidity ranking compared to other coffee-like beverages which result in a high acidity ranking. The disclosed beverage results in a high body and balance rating compared to other coffee-like beverages which result in a low body and balance rating. Overall, the disclosed beverage results in a higher quality coffee-like beverage than other coffee substitute beverages.

### Additional Terms & Definitions

As used herein, the phrase “exposing the substrate to a plurality of enzymes” refers to exposing the substrate to enzymes that are exogenous to the substrate. That is, the enzymes to which the substrate is exposed include more than those endogenously present within or on the substrate. Accordingly, “exposing the substrate to a plurality of enzymes” involves adding enzymes (directly and/or via inoculation with an enzyme-generating organism) rather than simply malting the substrate and allowing endogenous enzyme action to take place.

As used herein, “aging” refers to a process, following exposure of the substrate to the enzymes, of allowing the substrate and enzymes to interact for a selected time period to enable enzymatic hydrolysis of components of the substrate. Aging can be carried out at the temperatures and time periods disclosed herein.

While certain embodiments of the present disclosure have been described in detail, with reference to specific configurations, parameters, components, elements, etcetera, the descriptions are illustrative and are not to be construed as limiting the scope of the claimed invention.

Furthermore, it should be understood that for any given element of component of a described embodiment, any of the possible alternatives listed for that element or component may generally be used individually or in combination with one another, unless implicitly or explicitly stated otherwise.

In addition, unless otherwise indicated, numbers expressing quantities, constituents, distances, or other measurements used in the specification and claims are to be understood as optionally being modified by the term “about” or its synonyms. When the terms “about,” “approximately,” “substantially,” or the like are used in conjunction with a stated amount, value, or condition, it may be taken to mean an amount, value or condition that deviates by less than 20%, less than 10%, less than 5%, less than 1%, less than 0.1%, or less than 0.01% of the stated amount, value, or condition. At the very least, and not as an attempt to limit the application of the doctrine of equivalents to the scope of the claims, each numerical parameter should be construed in light of the number of reported significant digits and by applying ordinary rounding techniques.

Any headings and subheadings used herein are for organizational purposes only and are not meant to be used to limit the scope of the description or the claims.

It will also be noted that, as used in this specification and the appended claims, the singular forms “a,” “an” and “the” do not exclude plural referents unless the context clearly dictates otherwise. Thus, for example, an embodiment referencing a singular referent may also include two or more such referents.

The embodiments disclosed herein should be understood as comprising/including disclosed components or method steps, and may therefore include additional components or method steps not specifically described. Optionally, the embodiments disclosed herein are essentially free or completely free of components or method steps that are not specifically described. That is, non-disclosed components or method steps may optionally be essentially omitted or completely omitted from the disclosed embodiments. For example, particular fungi, enzymes, and/or substrate components not specifically described herein may be essentially or completely omitted.

An embodiment that “essentially omits” or is “essentially free of” a component may include trace amounts and/or non-functional amounts of the component. For example, an “essentially omitted” component may be included in an amount no more than 2.5%, no more than 1%, no more than 0.1%, or no more than 0.01% by total weight of the relevant composition (e.g., substrate product or beverage).

It will also be appreciated that embodiments described herein may also include properties and/or features (e.g., ingredients, components, members, elements, parts, and/or portions) described in one or more separate embodiments and are not necessarily limited strictly to the features expressly described for that particular embodiment. Accordingly, the various features of a given embodiment can be combined with and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include such features.

It will also be appreciated that embodiments described herein may also include properties and/or features (e.g., ingredients, components, members, elements, parts, and/or portions) described in one or more separate embodiments and are not necessarily limited strictly to the features expressly described for that particular embodiment. Accordingly, the various features of a given embodiment can be combined with and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include such features.

### EXAMPLE EMBODIMENTS

The following represent example embodiments. Any example embodiment can be combined with one or more of the other example embodiments.

Embodiment 1. A method of manufacturing a substrate prepared for use in making a beverage, the method comprising: providing a starch-containing and protein-containing substrate, wherein the substrate has not been germinated; exposing the substrate to a plurality of enzymes, the enzymes comprising at least glycosidase and protease enzymes; aging the substrate while exposed to the plurality of enzymes; and subjecting the substrate to a temperature sufficient to initiate a Maillard reaction.

Embodiment 2. The method of embodiment 1, further comprising physically processing the substrate following the Maillard reaction.

Embodiment 3. The method of any of embodiment 1 or 2, wherein the physical processing comprises grinding the substrate to increase the surface area to volume ratio of the substrate.

Embodiment 4. The method of any of embodiments 1-3, wherein the substrate comprises one or more cereal grains, pseudocereals, legumes, mushrooms, tubers, nuts, seeds, or roots.

Embodiment 5. The method of any of embodiments 1-4, wherein the cereal grain or pseudocereal comprises one or more of wheat, rye, oats, barley, rice, millet, corn/maize, sorghum, triticale, buckwheat, quinoa, chia, amaranth, breadnut, cañahua, cockscomb, pitseed goosefoot, or acacia.

Embodiment 6. The method of any of embodiments 1-5, wherein the substrate is a product of one or more of the cereal grains or pseudocereal.

Embodiment 7. The method of any of embodiments 1-6, wherein the substrate is pasta, bread, or crackers.

Embodiment 8. The method of any of embodiments 1-7, wherein the step of exposing the substrate to a plurality of enzymes comprises inoculating the substrate with an inoculant comprising one or more Aspergillus fungi and allowing a fermentation process to occur prior to carrying out the step of aging the substrate.

Embodiment 9. The method of any of embodiments 1-8, wherein the Aspergillus fungus comprises Aspergillus oryzae, Aspergillus sojae, Aspergillus awamori, Aspergillus luchuensis, or combinations thereof.

Embodiment 10. The method of any of embodiments 1-9, wherein the fermentation process comprises fermenting in an aerobic environment.

Embodiment 11. The method of any of embodiments 1-10, wherein aging the substrate comprises aging in an anaerobic environment.

Embodiment 12. The method of any of embodiments 1-11, wherein the fermentation process is carried out at a first temperature and aging is carried out at a second temperature.

Embodiment 13. The method of any of embodiments 1-12, wherein the first temperature is 70° F. to 95° F., such as 75° F. to 90° F.

Embodiment 14. The method of any of embodiments 1-13, wherein the second temperature is 33° F. to 50° F., or such as 35° F. to 45° F.

Embodiment 15. The method of any of embodiments 1-14, wherein the second temperature is lower than the first temperature.

Embodiment 16. The method of any of embodiments 1-15, wherein the fermentation process is carried out for a first time period and aging is carried out for a second time period.

Embodiment 17. The method of any of embodiments 1-16, wherein the first time period is 24 hours to 72 hours, such as 36 hours to 60 hours.

Embodiment 18. The method of any of embodiments 1-17, wherein the second time period is 4 hours or greater, such as 96 hours or more, such as 5 days or more, 7 days or more, 10 days or more, 12 days or more, or 14 days or more.

Embodiment 19. The method of any of embodiments 1-18, wherein the second time period is longer than the first time period, such as longer by a factor of at least 1.5, at least 2, at least 2.5, at least 3, at least 3.5, at least 4, at least 4.5, at least 5, at least 5.5, at least 6, at least 6.5, at least 7, at least 7.5, at least 8, at least 8.5, at least 9, at least 9.5, or at least 10.

Embodiment 20. The method of any of embodiments 1-19, wherein the step of exposing the substrate to a plurality of enzymes comprises exposing the plurality of enzymes directly to the substrate.

Embodiment 21. The method of any of embodiments 1-20, wherein the substrate is not additionally inoculated with an Aspergillus fungus.

Embodiment 22. The method of any of embodiments 1-21, wherein the substrate is exposed to the plurality of enzymes at a temperature of 40° F. to 90° F.

Embodiment 23. The method of any of embodiments 1-22, wherein the substrate is exposed to the plurality of enzymes for a temperature and time period within ±20%, or ±10%, or ±5% of: Time (days)=23466/Temperature (° F.)²−0.66.

Embodiment 24. The method of any of embodiments 1-23, wherein the step of subjecting the substrate to a temperature sufficient to initiate the Maillard reaction comprises subjecting the substrate to room temperature.

Embodiment 25. The method of any of embodiments 1-24, wherein the step of subjecting the substrate to a temperature sufficient to initiate the Maillard reaction comprises subjecting the substrate to a temperature of 200° F. to 450° F.

Embodiment 26. The method of any of embodiments 1-25, wherein the step of subjecting the substrate to a temperature sufficient to initiate the Maillard reaction comprises subjecting the substrate to a temperature and time period within ±20%, or ±10%, or ±5% of: Time (hours)=e^{2078/Temperature (° F.)-2.32}.

Embodiment 27. The method of any of embodiments 1-26, wherein the plurality of enzymes comprises an α-amylase, glucoamylase, β-galactosidase, β-glucosidase, β-glucanase (such as Endo-1,4-β-glucanase), protease (such as an acid, neutral, and/or alkaline protease), lipase, tannase, glutaminase, keratinase, or combination thereof.

Embodiment 28. The method of any of embodiments 1-27, further comprising subjecting the substrate to liquid-solid extraction, using water, to obtain a beverage.

Embodiment 29. The method of any of embodiments 1-28, wherein the liquid-solid extraction comprises percolation, immersion, pressurized percolation, or pressurized immersion.

Embodiment 30. The method of any of embodiments 1-29, wherein aging the substrate includes adding yeast to the substrate.

Embodiment 31. The method of any of embodiments 1-30, wherein the yeast is Kvass yeast, Saison yeast, or a combination thereof.

Embodiment 32. A prepared substrate for use in making a beverage, manufactured according to a method as in any of embodiments 1-31.

Embodiment 33. A beverage made by subjecting the prepared substrate of any of embodiments 1-32 to liquid-solid extraction using water.

1. A method of manufacturing a substrate prepared for use in making a beverage, the method comprising:
providing a starch-containing and protein-containing substrate;
exposing the substrate to a plurality of enzymes, the enzymes comprising at least glycosidase and protease enzymes;
aging the substrate while exposed to the plurality of enzymes for a time period sufficient to convert at least a portion of the starch and protein into simple sugars and amino acids; and
subjecting the substrate to a temperature sufficient to initiate a Maillard reaction.

2. The method of claim 1, further comprising physically processing the substrate following the Maillard reaction.

3. The method of claim 2, wherein the physical processing comprises grinding the substrate to increase the surface area to volume ratio of the substrate.

4. The method of claim 1, wherein the substrate comprises one or more cereal grains, pseudocereals, legumes, mushrooms, tubers, nuts, seeds, or roots, wherein the cereal grain or pseudocereal comprises one or more of wheat, rye, oats, barley, rice, millet, corn/maize, sorghum, triticale, buckwheat, quinoa, chia, amaranth, breadnut, cañahua, cockscomb, pitseed, goosefoot, or acacia.

5. The method of claim 4, wherein the substrate comprises barley and/or oats.

6. The method of claim 1, wherein the step of exposing the substrate to a plurality of enzymes comprises inoculating the substrate with an inoculant comprising an organism that generates the plurality of enzymes and allowing a fermentation process to occur prior to carrying out the step of aging the substrate.

7. The method of claim 6 wherein the one or more fungi comprises one or more Aspergillus fungi.

8. The method of claim 7, wherein the one or more Aspergillus fungi comprises Aspergillus oryzae, Aspergillus sojae, Aspergillus awamori, Aspergillus luchuensis, or a combination thereof.

9. The method of claim 6, wherein the fermentation process is carried out in an aerobic environment and optionally wherein the aging process is carried out in an anaerobic environment.

10. The method of claim 6, wherein the fermentation process is carried out at a first temperature and aging is carried out at a second, different temperature.

11. The method of claim 10, wherein the first temperature is 70° F. to 95° F. and optionally wherein the second temperature is 33° F. to 50° F.

12. The method of claim 6, wherein the fermentation process is carried out for a first time period and aging is carried out for a second, different time period, wherein the second time period is longer than the first time period.

13. The method of claim 1, wherein the step of subjecting the substrate to a temperature sufficient to initiate the Maillard reaction comprises subjecting the substrate to a temperature of 200° F. to 550° F.

14. The method of claim 1, wherein the plurality of enzymes comprises an α-amylase, glucoamylase, β-galactosidase, β-glucosidase, β-glucanase, protease, lipase, tannase, glutaminase, keratinase, or combination thereof.

15. The method of claim 1, further comprising subjecting the substrate to liquid-solid extraction, using water, to obtain a beverage.

16. The method of claim 1, further comprising adding yeast to the substrate prior to or during the aging step.

17. The method of claim 16, wherein the yeast comprises Kveik yeast, Saison yeast, or a combination thereof.

18. A prepared substrate for use in making a beverage, the prepared substrate manufactured by subjecting a cereal grain to a process comprising:
exposing the cereal grain to a plurality of enzymes, the enzymes comprising at least glycosidase and protease enzymes, wherein the cereal grain is not germinated when exposed to the plurality of enzymes;
aging the cereal grain while exposed to the plurality of enzymes; and
subjecting the cereal grain to a temperature sufficient to initiate a Maillard reaction.

19. The prepared substrate of claim 18, wherein:
the step of exposing the substrate to a plurality of enzymes comprises inoculating the substrate with an inoculant comprising an Aspergillus fungi and allowing a fermentation process to occur prior to carrying out the step of aging the substrate;
wherein the fermentation process is carried out at a temperature of 70° F. to 95° F. for a period of 24 to 72 hours, and
wherein aging is carried out at 33° F. to 50° F. for at least 96 hours.

20. The prepared substrate of claim 18, further comprising adding yeast to the substrate prior to or during the aging step.
